(19) United States
(12) Patent Application Publication
(10) Pub. No.: US 2007/0182767 A1
(43) Pub. Date: Aug. 9, 2007

(54) Method of forming hydrophobic coating layer on surface of nozzle plate of inkjet head

(75) Inventors: Tae-woon Cha, Seoul (KR); Jae-woo Chung, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/526,611

(22) Filed: Sep. 26, 2006

(30) Foreign Application Priority Data
Feb. 7, 2006 (KR) 2006-11838

(51) Int. Cl. B05D 5/00; B41J 2/01

(52) U.S. Cl. 347/1; 427/256

(57) ABSTRACT

An inkjet head nozzle plate having a hydrophobic coating layer and a method of forming a hydrophobic coating layer on the inkjet nozzle plate. The method including preparing a stamp and a nozzle plate having a plurality of nozzles, applying a hydrophobic material to the stamp, bonding the hydrophobic material to the nozzle plate by moving the stamp onto the nozzle plate and heating the nozzle plate to bond the hydrophobic material of the stamp to the nozzle plate, and separating the stamp from the nozzle plate. Portions of the hydrophobic material bonded to the nozzle plate remain at the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

### CROSS-REFERENCE TO RELATED APPLICATIONS

This application claims priority under 35 U.S.C. §119(a) from Korean Patent Application No. 10-2006-0011838, filed on Feb. 7, 2006, in the Korean Intellectual Property Office, the disclosure of which is incorporated herein in its entirety by reference.

### BACKGROUND OF THE INVENTION

1. Field of the Invention

The present general inventive concept relates to an inkjet head having a hydrophobic coating layer, and more particularly, to a method of forming a hydrophobic coating layer on a surface of a nozzle plate of an inkjet head.

2. Description of the Related Art

Generally, inkjet heads are devices for printing an image on a printing medium by ejecting ink droplets onto a desired region of the printing medium. Depending on an ink ejecting method, the inkjet heads can be classified into two types: thermal inkjet heads and piezoelectric inkjet heads. A thermal inkjet head generates bubbles in an ink to be ejected by using heat and ejects the ink utilizing an expansion of the bubbles, and a piezoelectric inkjet head ejects ink using a pressure generated by deforming a piezoelectric material.

FIG. 1 is a sectional view illustrating a conventional piezoelectric inkjet head, and FIG. 2 is a view illustrating problems caused by a surface treatment failure at a nozzle plate of an inkjet head.

Referring to FIG. 1, a manifold 11, a plurality of restrictors 12, and a plurality of pressure chambers 13 forming an ink flow channel are formed in a flow channel plate 10 of the piezoelectric inkjet head. A vibration plate 20 which can be deformed by piezoelectric actuators 40 is bonded to a top surface of the flow channel plate 10, and a nozzle plate 30 in which a plurality of nozzles 31 are formed is bonded to a bottom surface of the flow channel plate 10. The vibration plate 20 can be formed integrally with the flow channel plate 10, and the nozzle plate 30 can also be formed integrally with flow channel plate 10.

The manifold 11 is an ink passage supplying an ink from an ink reservoir (not shown) to the respective pressure chambers 13, and the restrictors 12 are ink passages allowing inflow of the ink from the manifold 11 to the pressure chambers 13. The pressure chambers 13 are filled with the ink supplied by the manifold 11 and are arranged at one side or both sides of the manifold 11. The nozzles 31 are formed through the nozzle plate 30 and connected to the respective pressure chambers 13. The vibration plate 20 is bonded to the top surface of the flow channel plate 10 to cover the pressure chambers 13. The vibration plate 20 is deformed by the operation of the piezoelectric actuators 40 to change pressures in the respective pressure chambers 13 to eject ink from the ink chambers 13. Each of the piezoelectric actuators 40 includes a lower electrode 41, a piezoelectric layer 42, and an upper electrode 43 that are sequentially stacked on the vibration plate 20. The lower electrode 41 is formed on the entire surface of the vibration plate 20 as a common electrode. The piezoelectric layer 42 is formed on the lower electrode 41 above each of the pressure chambers 13. The upper electrode 43 is formed on the piezoelectric layer 42 as a driving electrode to apply a voltage to the piezoelectric layer 42.

In the above-described piezoelectric inkjet head, a surface treatment of the nozzle plate 30 has an effect on an ink ejecting performance of the inkjet head, such as an ink ejecting speed and a straightness of the ink ejecting from the nozzles 31. That is, an inner surface of the nozzles 31 should have a hydrophilic surface, and an outer surface of the nozzle plate 30 should have a hydrophobic surface to increase the ink ejecting performance of the inkjet head.

Generally, a hydrophobic coating layer is formed on the nozzle plate 30 according to various known methods. Examples of conventional methods of forming a hydrophobic coating layer on the nozzle plate 30 include a dipping method and a depositing method. In the dipping method, the nozzle plate 30 is dipped into a hydrophobic material solution to form a hydrophobic coating layer on the nozzle plate 30. In the depositing method, a hydrophobic material is deposited on the nozzle plate 30 to form a hydrophobic coating layer.

However, in the conventional coating methods, it is difficult to form a hydrophobic coating layer only on the outer surface of the nozzle plate without also forming a hydrophobic coating layer on an inner surface of the nozzles 31. That is, the hydrophobic coating layer may be formed on the inner surfaces of the nozzles 31 unevenly. In this case, as illustrated in FIG. 2, ink droplets may not be straightly ejected from the nozzles 31, and a speed and a volume of the ejected droplets may not be not uniformly distributed, thereby deteriorating the ink ejecting performance of the inkjet head.

### SUMMARY OF THE INVENTION

The present general inventive concept provides a method of forming a hydrophobic coating layer.

The present general inventive concept also provides a method of forming a hydrophobic coating layer on an outer surface of a nozzle plate of an inkjet head more uniformly.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a method of forming a hydrophobic coating layer on a nozzle plate of an inkjet head, the method including preparing a stamp and a nozzle plate having a plurality of nozzles, applying a hydrophobic material to the stamp, bonding the hydrophobic material to the nozzle plate by moving the stamp onto the nozzle plate and heating the nozzle plate to bond the hydrophobic material of the stamp to the nozzle plate, and separating the stamp from the nozzle plate, wherein portions of the hydrophobic material bonded to the nozzle plate remain on the nozzle plate to form the hydrophobic coating layer on the nozzle plate, and other portions of the hydrophobic material corresponding to the nozzles of the nozzle plate are separated from the nozzle plate when the stamp is separated from the nozzle plate.

The applying of the hydrophobic material to the stamp may include preparing a solution containing the hydrophobic material and a solvent, applying the solution to the stamp, and evaporating the solvent of the solution. The solvent of the solution may be selected from the group consisting of THF (tetrahydrofuran), acetone, toluene, xylene, and ethanol or a mixture thereof. The solution may include 5 to 20 wt % of the hydrophobic material dissolved in the solvent. The applying of the solution may be performed by a spin coating method or a dipping method.

The hydrophobic material may be a fluoride compound or a sulfur compound.

The stamp may be formed of PDMS (polydimethylsiloxane).

The thickness of the hydrophobic coating layer formed on the nozzle plate may be adjusted by performing the applying of the hydrophobic material to the stamp, the bonding of the hydrophobic material to the nozzle plate, and the separating of the stamp from the nozzle plate two or more times.

The foregoing and/or other aspects and utilities of the present general inventive concept are also achieved by providing a method of forming a hydrophobic coating layer on a nozzle plate having a plurality of nozzles, on a completely formed inkjet head, the method including preparing a stamp and a nozzle plate having a plurality of nozzles, applying a hydrophobic material to the stamp, bonding the hydrophobic material to the nozzle plate by moving the stamp onto the nozzle plate and heating the nozzle plate to attach the hydrophobic material of the stamp to the nozzle plate, and separating the stamp from the nozzle plate, wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

The foregoing and/or other aspects and utilities of the present general inventive concept are also achieved by providing a method of forming a hydrophobic coating layer on a nozzle plate having a plurality of nozzles, without forming the hydrophobic coating layer on the inner surface of the nozzles, the method including applying a hydrophobic material to a stamp, bonding the hydrophobic material of the stamp to the nozzle plate by moving the stamp into contact with the nozzle plate, and separating the stamp from the nozzle plate.

The bonding of the hydrophobic material of the stamp to the nozzle plate may include moving the stamp into contact with the nozzle plate and heating the nozzle plate to bond the hydrophobic material of the stamp to the nozzle plate, wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

The applying of the hydrophobic material to the stamp may include preparing a solution containing the hydrophobic material and a solvent, applying the solution to the stamp, and removing the solvent of the solution.

The thickness of the hydrophobic coating layer formed on the nozzle plate may be adjusted by performing the applying of the hydrophobic material to the stamp, the bonding of the hydrophobic material of the stamp to the nozzle plate by moving the stamp into contact with the nozzle plate, and the separating of the stamp from the nozzle plate two or more times.

The foregoing and/or other aspects and utilities of the present general inventive concept are also achieved by providing an inkjet head including a nozzle plate having a plurality of nozzles and a hydrophobic coating layer, wherein the hydrophobic coating layer is not formed on the inner surfaces of the nozzles.

According to the present general inventive concept, the hydrophobic coating layer is uniformly formed only on the outer surface of the nozzle plate, without forming the hydrophobic coating layer on the inner surfaces of the nozzles, so that the ink ejecting performance of the inkjet head having the plurality of nozzles can be improved.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional piezoelectric inkjet head;

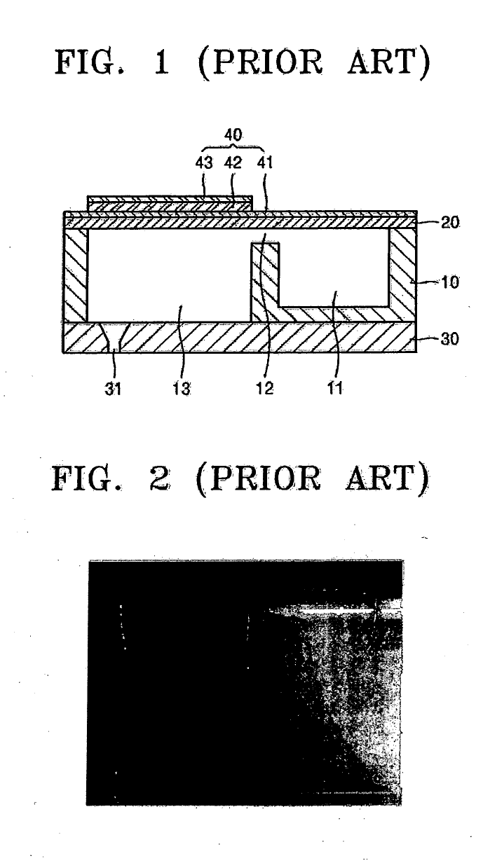

FIG. 2 is a view illustrating problems caused by surface a treatment failure at a nozzle plate of an inkjet head.

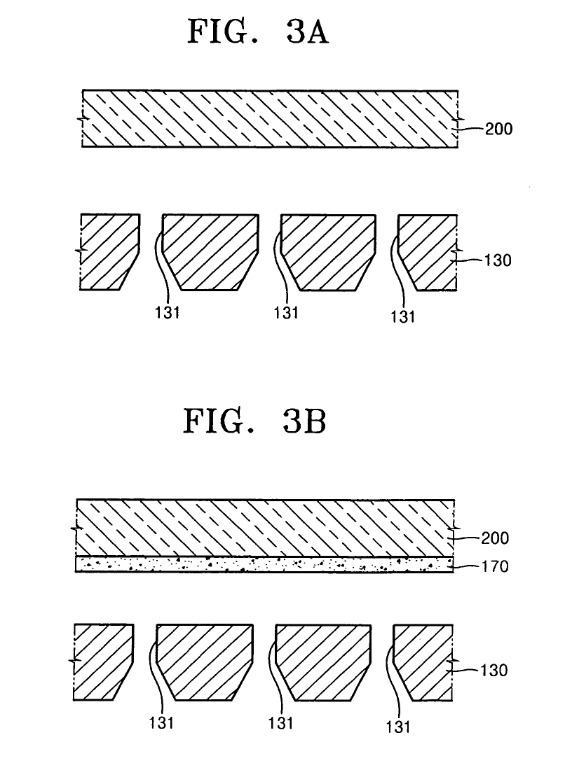

FIGS. 3A through 3D are views illustrating a method of forming a hydrophobic coating layer on a surface of a nozzle plate of an inkjet head according to an embodiment of the present general inventive concept; and

FIG. 4 is a view illustrating a method of forming a hydrophobic coating layer on a surface of a nozzle plate of a completely formed piezoelectric inkjet head according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

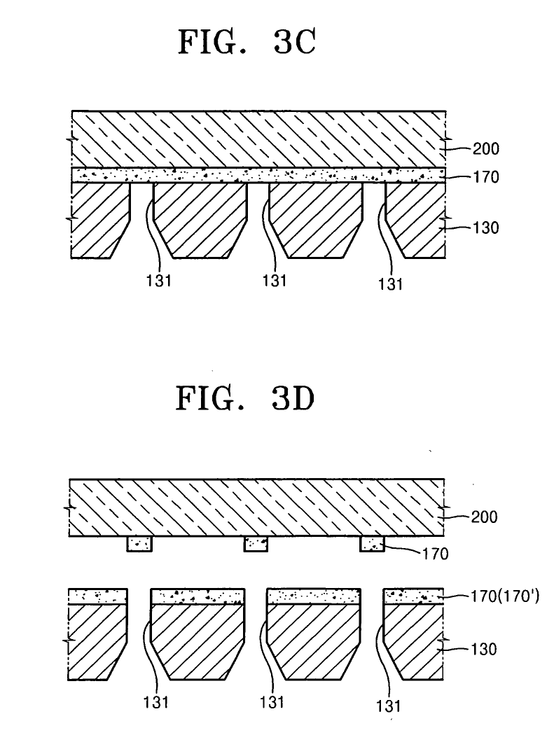

FIGS. 3A through 3D are views illustrating a method of forming a hydrophobic coating layer on a surface of a nozzle plate of an inkjet head according to an embodiment of the present general inventive concept. Although a portion of a nozzle plate is illustrated in the drawings, the nozzle plate generally has several tens to several hundreds of nozzles arranged in one or more lines.

Referring to FIG. 3A, a stamp 200 and a nozzle plate 130 with a plurality of nozzles 131 are prepared. The nozzle plate 130 may be formed of a silicon wafer, a glass substrate, a metal substrate, or the like. The stamp 200 may be formed of a high molecular substance such as polydimethylsiloxane (PDMS).

Referring to FIG. 3B, a hydrophobic material 170 is applied to the stamp 200 to a predetermined thickness. The hydrophobic material 170 may be applied to the stamp 200 to a thickness of about 5 nm to 10 nm through a spin coating or dipping method using a solution containing the hydrophobic material 170. The solution may include a solvent, such as perfluoro compound, tetrahydrofuran (THF), toluene, xylene, ethanol, or the like, and 5 to 20 wt % (e.g., 10 wt %) of the hydrophobic material 170 dissolved in the solvent. A typical hydrophobic material, such as a fluoride compound or a sulfur compound, can be used for the hydrophobic material 170. The solution applied to the stamp 200 is dried for a predetermined time to remove the solvent by evaporation. In this way, the hydrophobic material 170 is applied on the stamp 200.

Referring to FIG. 3C, the stamp 200 is moved onto the nozzle plate 130 to bond the hydrophobic material 170 to the nozzle plate 130. Here, the nozzle plate 130 is heated to a predetermined temperature, for example, to about 100° C. The nozzle plate 130 may be heated before, during, or after the hydrophobic material 170 makes contact with the nozzle plate 130. Since the nozzle plate 130 is heated, the surface of the hydrophobic material 170 making contact with the nozzle plate 130 is softened and firmly bonded to the nozzle plate 130.

Referring to FIG. 3D, the stamp 200 is moved away from the nozzle plate 130. Since the hydrophobic material 170 is firmly bonded to the nozzle plate 130 while loosely attached to the stamp 200, the coupling force between the hydrophobic material 170 and the nozzle plate 130 is larger than the coupling force between the hydrophobic material 170 and the stamp 200. Therefore, when the stamp 200 is moved away from the nozzle plate 130, portions of the hydrophobic material 170 bonded to the nozzle plate 130 remain on the nozzle plate 130 and thus form a hydrophobic coating layer 170′. Other portions of the hydrophobic material 170 corresponding to the nozzles 131 move together with the stamp 200, and thus these portions are removed from the nozzle plate 130.

In this way, the hydrophobic coating layer 170′ is formed on the outer surface of the nozzle plate 130 without forming the hydrophobic coating layer 170′ on the inner surface of the nozzles.

After the above described operations, and according to the present general inventive concept, the hydrophobic coating layer 170′ is uniformly formed on the outer surface of the nozzle plate 130 and not on the inner surfaces of the nozzles 131.

A thickness of the hydrophobic coating layer 170′ can be adjusted to a desired value by repeating the operations illustrated in FIGS. 3B, 3C, and 3D one or more times (e.g., two or three times) and/or by adjusting the concentration of the hydrophobic material 170 in the solution.

While the hydrophobic coating layer 170′ is formed on the nozzle plate 130 that is not bonded to an inkjet head in the above described embodiment, the present general inventive concept is not limited to this illustrated embodiment. As described below, the hydrophobic coating layer 170′ can be formed on the outer surface of the nozzle plate 130 of a completely formed piezoelectric inkjet head 100.

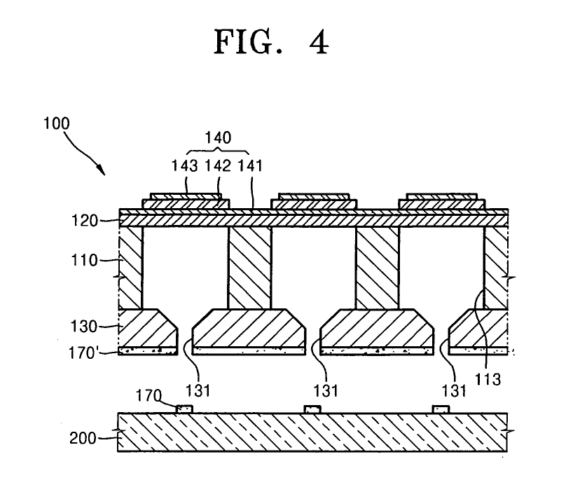

FIG. 4 is a view illustrating a method of forming a hydrophobic coating layer 170′ on a nozzle plate 130 of a completely formed piezoelectric inkjet head 100 according to another embodiment of the present general inventive concept.

Referring to FIG. 4, the completely formed piezoelectric inkjet head 100 includes a flow channel plate 110 having a plurality of pressure chambers 113, a vibration plate 120 bonded to a top surface of the flow channel plate 110 and covering the plurality of pressure chambers 113, and piezoelectric actuators 140 formed on the vibration plate 120. The inkjet head 100 further includes a nozzle plate 130 that is bonded to a bottom surface of the flow channel plate 110 and has a plurality of nozzles 131 formed therethrough. The flow channel plate 110 may include a manifold (not illustrated) and a plurality of restrictors. The piezoelectric actuators 140 provide ink ejecting forces to the respective pressure chambers 113. Each of the piezoelectric actuators 140 includes a lower electrode 141, a piezoelectric layer 142, and an upper electrode 143 that are sequentially formed on the vibration plate 120. The lower electrode 141 is formed on an entire top surface of the vibration plate 120 as a common electrode. The piezoelectric layer 142 is formed on the lower electrode 141 above each of the pressure chambers 113. The upper electrode 143 is formed on the piezoelectric layer 142 as a driving electrode to apply a voltage to the piezoelectric layer 142.

Meanwhile, the vibration plate 120 may be formed integrally with the flow channel plate 110, and the nozzle plate 130 may also be formed integrally with the flow channel plate 110.

While FIG. 4 illustrates a piezoelectric inkjet head 100 as an example of the inkjet head, the present general inventive concept is not limited to a piezoelectric inkjet head, and the hydrophobic coating layer formed under the method describe in the present general inventive concept may be formed on the nozzle plate of other types of completely formed inkjet heads, such as thermal inkjet heads.

The operations illustrated in FIGS. 3A through 3D can be performed on the completely formed inkjet head 100. In this case, the hydrophobic coating layer 170′ can be formed on an outer surface of the nozzle plate 130 while not being formed on inner surfaces of the nozzles 131. According to the present general inventive concept, the hydrophobic coating layer 170′ can be formed only on the outer surface of the nozzle plate 130 of the completely formed inkjet head 100, so that other parts of the completely formed inkjet head 100 are not affected by the hydrophobic material 170.

As described above, according to a method of forming the hydrophobic coating layer of the present general inventive concept, the hydrophobic coating layer can be uniformly formed only on the outer surface of the nozzle plate. Therefore, an ink ejecting performance of the inkjet head, such as an ink ejecting speed and a straightness of the ink being ejected from the nozzles can be improved, and thus the printing quality of the inkjet head can be improved.

Further, according to the present general inventive concept, the hydrophobic coating layer may be formed using a solution containing a hydrophobic material to first apply the hydrophobic material to a stamp, so that more types of hydrophobic materials can be used for the hydrophobic coating layer when compared with the related art. Furthermore, expensive depositing equipment is not required, thus decreasing the manufacturing costs of the inkjet head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of forming a hydrophobic coating layer on a nozzle plate of an inkjet head, comprising:
preparing a stamp and a nozzle plate having a plurality of nozzles;
applying a hydrophobic material to the stamp;
bonding the hydrophobic material to the nozzle plate by moving the stamp onto the nozzle plate and heating the nozzle plate to bond the hydrophobic material of the stamp to the nozzle plate; and
separating the stamp from the nozzle plate,
wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

2. The method of claim 1, wherein the applying of the hydrophobic material to the stamp comprises:
preparing a solution containing the hydrophobic material and a solvent;
applying the solution to the stamp; and
evaporating the solvent of the solution.

3. The method of claim 2, wherein the solvent of the solution is selected from the group consisting of perfluoro compound, THF (tetrahydrofuran), toluene, xylene, and ethanol.

4. The method of claim 3, wherein the solvent comprises a mixture of solvents and the evaporation of a solvent comprises the evaporation of one or more of the solvents.

5. The method of claim 2, wherein the hydrophobic material dissolved in the solvent comprises 5 to 20 wt % of the solution.

6. The method of claim 2, wherein the applying of the solution to the stamp is performed by a spin coating method or a dipping method.

7. The method of claim 1, wherein the hydrophobic material is a fluoride compound or a sulfur compound.

8. The method of claim 1, wherein the stamp is formed of PDMS (polydimethylsiloxane).

9. The method of claim 1, wherein the thickness of the hydrophobic coating layer formed on the nozzle plate can be adjusted by performing the applying of the hydrophobic material to the stamp, the bonding of the hydrophobic material to the nozzle plate, and the separating of the stamp from the nozzle plate two or more times.

10. The method of claim 1, wherein the inner surface of the nozzles is hydrophilic.

11. A method of forming a hydrophobic coating layer on a nozzle plate having a plurality of nozzles, on a completely formed inkjet head, the method comprising:
preparing a stamp and a nozzle plate having a plurality of nozzles;
applying a hydrophobic material to the stamp;
bonding the hydrophobic material to the nozzle plate by moving the stamp onto the nozzle plate and heating the nozzle plate to attach the hydrophobic material of the stamp to the nozzle plate; and
separating the stamp from the nozzle plate,
wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

12. A method of forming a hydrophobic coating layer on a nozzle plate having a plurality of nozzles, without forming the hydrophobic coating layer on the inner surface of the nozzles, the method comprising:
applying a hydrophobic material to a stamp;
bonding the hydrophobic material of the stamp to the nozzle plate by moving the stamp into contact with the nozzle plate; and
separating the stamp from the nozzle plate.

13. The method of claim 12, wherein the bonding of the hydrophobic material of the stamp to the nozzle plate comprises:
moving the stamp into contact with the nozzle plate; and
heating the nozzle plate to bond the hydrophobic material of the stamp to the nozzle plate,
wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

14. The method of claim 12, wherein the applying of the hydrophobic material to the stamp comprises:
preparing a solution containing the hydrophobic material and a solvent;
applying the solution to the stamp; and
removing the solvent of the solution.

15. The method of claim 12, wherein the thickness of the hydrophobic coating layer formed on the nozzle plate is adjusted by performing the applying of the hydrophobic material to the stamp, the bonding of the hydrophobic material of the stamp to the nozzle plate by moving the stamp into contact with the nozzle plate, and the separating of the stamp from the nozzle plate two or more times.

16. An inkjet head comprising:
a nozzle plate having a plurality of nozzles and a hydrophobic coating layer,
wherein the hydrophobic coating layer is not formed on the inner surfaces of the nozzles.

17. The inkjet head of claim 16, wherein the hydrophobic coating layer is formed on the nozzle plate by:
preparing a stamp and a nozzle plate having a plurality of nozzles;
applying a hydrophobic material to the stamp;
bonding the hydrophobic material to the nozzle plate by moving the stamp onto the nozzle plate and heating the nozzle plate to bond the hydrophobic material of the stamp to the nozzle plate; and
separating the stamp from the nozzle plate,
wherein portions of the hydrophobic material bonded to the nozzle plate remain on the nozzle plate to form the hydrophobic coating layer on the nozzle plate, and other portions of the hydrophobic material corresponding to the nozzles of the nozzle plate remain on the stamp and are separated from the nozzle plate when the stamp is separated from the nozzle plate.

18. The inkjet head of claim 17, wherein the applying of the hydrophobic material to the stamp comprises:
preparing a solution containing the hydrophobic material and a solvent;
applying the solution to the stamp; and
evaporating a solvent of the solution.

19. The inkjet of claim 17, wherein the thickness of the hydrophobic coating layer formed on the nozzle plate is adjusted by performing the applying of the hydrophobic material to the stamp, the bonding of the hydrophobic material to the nozzle plate by moving the stamp onto the nozzle plate and heating the nozzle plate to bond the hydrophobic material of the stamp to the nozzle plate, and the separating of the stamp from the nozzle plate two or more times.
